(19) United States
(12) Patent Application Publication
(10) Pub. No.: US 2026/0152062 A1
(43) Pub. Date: Jun. 4, 2026

(54) CRAWLER VEHICLE

(71) Applicant: PRINOTH S.P.A., Vipiteno (IT)

(72) Inventors: Günther Steiner, Vipiteno (IT); Martin Kirchmair, Vipiteno (IT); Francesco Salis, Vipiteno (IT); Alberto Paoletti, Vipiteno (IT)

(21) Appl. No.: 19/395,843

(22) Filed: Nov. 20, 2025

(30) Foreign Application Priority Data
Nov. 29, 2024 (IT) 102024000027078
Dec. 18, 2024 (IT) 102024000028929
Feb. 6, 2025 (IT) 102025000002259
Mar. 11, 2025 (IT) 102025000004972

(51) Int. Cl. B60K 35/22; B60K 35/81; B62D 33/06

(52) U.S. Cl. CPC B60K 35/22; B60K 35/81; B62D 33/06; B60K 2360/176; B60K 2360/182

(57) ABSTRACT

A crawler vehicle having a frame; a driver's cab mounted on the frame; a seat for a driver of the crawler vehicle arranged inside the driver's cab and a display, which is arranged in the driver's cab and is configured to display a screen reproducing operative information. The screen is divided into a plurality of screen portions. The crawler vehicle also includes a control system which is in communication with the display and is configured to control the screen displayed by the display.

### PRIORITY CLAIM

This application claims the benefit of and priority to Italian Patent Application No. 102024000027078, filed on Nov. 29, 2024, and claims the benefit of and priority to Italian Patent Application No. 102024000028929, filed on Dec. 18, 2024 and claims the benefit of and priority to Italian Patent Application No. 102025000002259, filed on Feb. 6, 2025, and claims the benefit of and priority to Italian Patent Application No. 102025000004972, filed on Mar. 11, 2025, the entire contents of which are each incorporated by reference herein.

### TECHNICAL FIELD

The present disclosure relates to a crawler vehicle, such as a crawler vehicle used for the preparation of ski runs.

### BACKGROUND

Crawler type vehicles are used to advance along off-road routes for the purpose of transporting goods and/or people and/or to carry out a wide range of different jobs, such as preparing the snowpack of ski runs or cleaning beaches, or for agricultural operations.

A crawler vehicle comprises a frame, a driver's cab mounted on the frame, and a pair of motorized tracks. In particular, the driver's cab is equipped with a seat for a driver and with a user interface, which is arranged near the seat, comprises a control device to allow the driver to control the crawler vehicle, and allows the display of crawler vehicle operational parameters, such as travel speed or remaining range of the crawler vehicle.

However, as the relative complexity of the working environment, the tasks to be performed and the crawler vehicle itself continues to increase, more and more information needs to be displayed in crawler vehicles and, as a result, existing user interfaces are inadequate for this purpose.

### SUMMARY

An aim of the present disclosure is to realize a crawler vehicle that mitigates certain of the drawbacks of certain of the prior art.

In accordance with certain embodiments of the present disclosure, a crawler vehicle, such as a crawler vehicle for the preparation of ski runs, is realized. The crawler vehicle of these embodiments is configured to advance in a travelling direction and comprises a frame; a driver's cab mounted on the frame; a seat for a driver of the crawler vehicle arranged within the driver's cab and a screen which is arranged in the driver's cab and is configured to display a screen reproducing operative information, wherein the screen is divided into a plurality of screen portions. The crawler vehicle of these embodiments also comprises a control system which is in communication with the screen and is configured to control the screen displayed by the screen. In accordance with these embodiments, the driver of the crawler vehicle can display on a single screen an amount of operative information appropriate to the relative complexity of the operational circumstances and can manage the screen displayed by the screen in a personalized manner. In other words, the driver of the crawler vehicle can set the screen displayed by the display according to their preferences and display at any time all the operative information they need.

In certain embodiments, the operative information comprises one or more of operational parameters of the crawler vehicle, information on the operations to be performed, information on characteristics of the environment surrounding the crawler vehicle, images acquired outside the driver's cab and/or videos acquired outside the driver's cab. In this way, it is possible to provide the driver of the crawler vehicle with all the necessary operative information to facilitate the driving and control tasks of the crawler vehicle.

In certain embodiments, the crawler vehicle comprises a user interface, which is in communication with the control system and is configured to receive commands from the driver of the crawler vehicle and to transmit the commands to the control system. In more detail, the user interface is arranged in the proximity of the seat so as to be within reach of the driver of the crawler vehicle when the driver is seated on the seat.

In certain embodiments, the control system is configured to control the screen of the display to change the operative information reproduced by each screen portion, such as based on or as a function of the commands given by the driver of the crawler vehicle via the user interface. In this way, the configuration of the screen displayed by the screen can be set based on the personal needs of each driver of the crawler vehicle.

In certain embodiments, the display extends for a first length along a first direction and for a second length along a second direction substantially perpendicular to the first direction. In certain instances, the first length is greater than three times the second length. In this way, it is possible to display a large amount of operative information arranged in an aligned manner along the first direction.

In certain embodiments, the display has a curved profile to offer the driver of the crawler vehicle an immersive visual experience, reducing the distortion of the screen displayed and guaranteeing a wide field of vision to the driver.

In certain embodiments, the display is arranged in front of the seat or to the side of the seat. In more detail, the driver's cab comprises a windscreen, two lateral windows, two lateral uprights, each of which is arranged between the windscreen and the respective lateral window, a lower platform, and a roof; the display extending from the roof of the driver's cab, in certain instances in proximity of the windscreen, or being supported by the lower platform of the driver's cab, in certain instances in proximity of the windscreen, or being fixed to one of the lateral uprights of the driver's cab. In this way, it is possible to maintain an unobstructed view of the driver of the crawler vehicle through a central portion of the windscreen while the driver is seated on the seat. In practice, it is possible to prevent the screen from obstructing the driver's view through the windshield.

In certain embodiments, the control system is configured to control the screen displayed by the display to display in a first screen portion of the plurality of screen portions a representation of at least a portion of the crawler vehicle and a visual indicator indicative of the presence of obstacles in proximity of the crawler vehicle. In this way, it is possible to inform the driver of the crawler vehicle about the possible presence of obstacles in proximity of a certain portion of the crawler vehicle.

In certain embodiments, the crawler vehicle comprises at least one acquisition device, which is in communication with the control system and is configured to acquire videos and/or images of the environment surrounding the crawler vehicle. The control system of these embodiments is configured to control the screen displayed by the display so as to display the videos and/or images acquired by the at least one acquisition device in a second screen portion of the plurality of screen portions so as to provide the driver with a view outside the driver's cab.

In certain embodiments, the control system is configured to process the videos and/or the images detected by the at least one acquisition device, to identify a position and/or a conformation of reference elements in the environment surrounding the crawler vehicle as a function of the processed videos and/or images, and to indicate the contours of each reference element in the second portion of the screen displayed by the display. In this way, it is possible to provide the driver of the crawler vehicle with information relating to the type and position of the reference elements in the environment surrounding the crawler vehicle.

In certain embodiments, the at least one acquisition device points in a direction substantially opposite to the travelling direction of the crawler vehicle. The control system of these embodiments is configured to control the screen displayed by the display so as to display, in real time, in a third screen portion of the plurality of screen portions the videos and/or the images acquired by the at least one acquisition device in the direction substantially opposite to the travelling direction of the crawler vehicle. In this way, the rear-view mirrors mounted outside the driver's cab can, in certain instances, be eliminated. Furthermore, since the screen is arranged within the driver's cab, it is possible to improve the driver's rear and side visibility as the driver is not forced to look through the driver's cab windows, which can be relatively dirty or foggy and, consequently, can partially obstruct the driver's view outside the driver's cab.

### BRIEF DESCRIPTION OF THE DRAWINGS

Further characteristics and advantages of the present disclosure will become clear from the following description of non-limiting examples of embodiment thereof, with reference to the figures of the attached drawings, wherein:

FIG. 1 is a side view, with parts removed for clarity and schematized parts, of a crawler vehicle realized in accordance with the present disclosure;

FIGS. 2 to 6 are perspective views, with parts removed for clarity and schematized parts, of a detail of the crawler vehicle of FIG. 1 realized in accordance with respective forms of implementation;

FIG. 7 is a front view, with parts removed for clarity, of a screen of the crawler vehicle of FIG. 1;

FIG. 8 is a plan view, with parts removed for clarity, of the screen of FIG. 7; and

FIGS. 9 and 10 are views of a detail of the screen of the display of FIG. 7 according to respective display modes.

### DETAILED DESCRIPTION

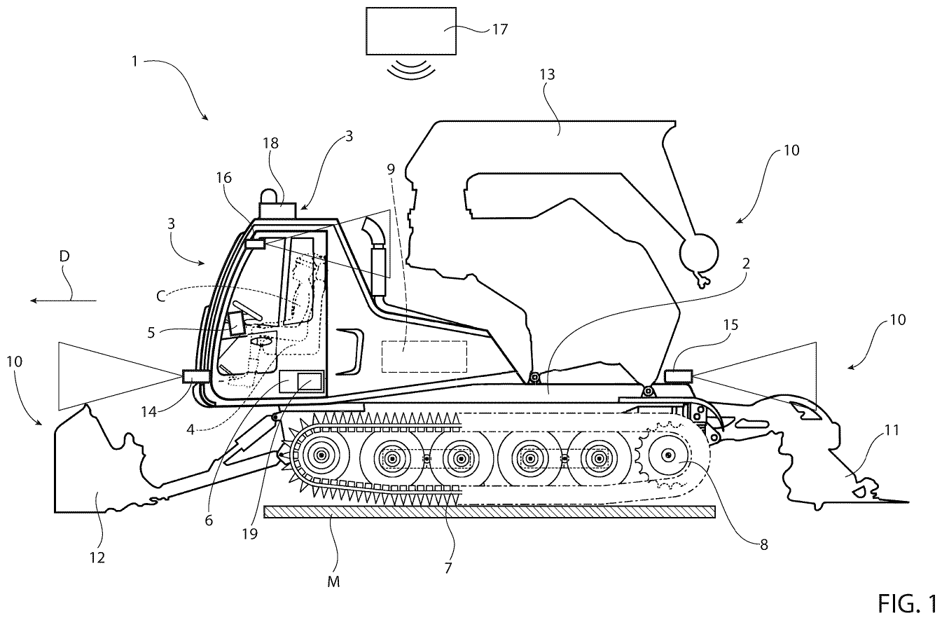

With reference to FIG. 1, 1 denotes as a whole a crawler vehicle, which in the case shown is used for preparing a snowpack M of ski runs. In certain embodiments, the crawler vehicle 1 is a snow groomer. In more detail, the crawler vehicle 1 of these embodiments is used for preparing one or more of downhill ski runs, cross-country ski runs, ski-jumping ramps, half-pipe ski runs, snow-parks, and/or snowmobile tracks.

In accordance with certain further embodiments, the crawler vehicle 1 can be used for the maintenance of sandy areas, such as beaches, or for agricultural operations, such as one or more of harvesting agricultural products, handling agricultural products, forage silage, bagasse harvesting and/or bagasse handling.

In additional embodiments (not shown in the figures), the crawler vehicle 1 comprises a shredder, such as a shredder positioned at the front of the crawler vehicle 1, that can be used for shredding vegetation.

In accordance with certain embodiments of the present disclosure, the crawler vehicle 1 is configured to advance in a travelling direction D and comprises a frame 2; a driver's cab 3 mounted on the frame 2; a seat 4 for a driver C of the crawler vehicle 1 arranged inside the driver's cab 3; and a display 5, which is arranged in the driver's cab 3 and is configured to display a screen reproducing operative information. The screen is divided into a plurality of screen portions; The crawler vehicle also includes a control system 6 which is in communication with the display 5 and is configured to control the screen displayed by the display 5.

In certain embodiments, the operative information comprises one or more of operational parameters of the crawler vehicle 1, information on the operations to be performed, information on characteristics of the environment surrounding the crawler vehicle 1, images acquired outside the driver's cab 3 and/or videos acquired outside the driver's cab 3.

In certain embodiments, the control system 6 is equipped with wireless connection capabilities (e.g., via a local communication network or via a mobile data network and an internet connection) for connection to a remote monitoring system 17 of a ski resort. In more detail, the remote monitoring system 17 is configured to receive data from the control system 6, to process the received data, and to monitor and/or control a fleet of crawler vehicles 1 based on or as a function of the processed data. In accordance with certain embodiments, the remote monitoring system 17 implements artificial intelligence algorithms.

In additional embodiments, the crawler vehicle 1 comprises a pair of tracks 7 (only one of which is visible in FIG. 1); a pair of drive wheels 8 (only one of which is visible in FIG. 1), each of which is coupled to a respective track 7; a propulsion system 9 (e.g., internal combustion or electric or hydrogen-powered) configured to transmit power to the drive wheels 8; and an assembly of accessory devices 10 connected to the frame 2.

In the non-limiting embodiment of the present disclosure described and shown, the assembly of accessory devices 10 comprises a tiller 11, a shovel 12, and a winch 13. It is understood that the crawler vehicle 1 does not necessarily comprise all of the accessory devices 10 mentioned above. For example, the crawler vehicle 1 may comprise any one or two of the accessory devices 10 selected from the tiller 11, shovel 12 and winch 13.

Furthermore, the crawler vehicle 1 of certain embodiments comprises at least one acquisition device 14, 15, 16, which is in communication with the control system 6 and is configured to acquire videos and/or images of the environment surrounding the crawler vehicle 1.

In certain embodiments, each acquisition device 14, 15, 16 comprises one or more of a lidar, a radar, an infrared video camera, a stereoscopic camera, a camera and/or a video camera such as at 270° or 360°.

In accordance with certain embodiments of the present disclosure, each acquisition device 14, 15, 16 comprises a thermographic camera configured to acquire thermographic images and/or thermographic videos of the environment surrounding the crawler vehicle 1. In certain embodiments, each acquisition device 14, 15, 16 comprising a thermographic camera that enables one or more of the following to be detected: snow temperature(s); snow humidity; air temperature(s); air humidity; snowpack profile M (i.e., based on the temperature difference between snowpack M and air); and/or a distinguishment of a worked surface of snowpack M from an unworked surface of snowpack M. The use of the thermographic camera is particularly useful in conditions of relatively poor visibility, such as at night or in foggy conditions. In certain embodiments, the acquisition device 14 is arranged in a front portion of the crawler vehicle 1, is facing in the travelling direction D, and is configured to acquire videos and/or images of the environment surrounding the crawler vehicle 1 in the travelling direction D.

In certain embodiments, the acquisition device 15 is facing in a direction substantially opposite to the travelling direction D and is configured to acquire video and/or images from a respective rear portion of the crawler vehicle 1. In the non-limiting embodiment of the present disclosure described and shown, the acquisition device 15 is mounted on a rear portion of the crawler vehicle 1, in a retracted position with respect to one or more of the direction of travel, the drive wheels 8 and/or the winch 13, and is configured to acquire videos and/or images of a portion of the snowpack M, in certain instances already processed, to the rear of the tiller 11.

In accordance with certain embodiments of the present disclosure (not shown in the figures), the acquisition device 15 is attached to the tiller 11.

In certain embodiments, the crawler vehicle 1 comprises a pair of acquisition devices 16 (only one of which is visible in FIG. 1), each of which is facing in a direction substantially opposite to the travelling direction D and is configured to acquire video and/or images from a respective external lateral portion of the driver's cab 3.

In practice, the crawler vehicle 1 of certain embodiments has no rear-view mirrors. Each acquisition device 16 is configured to acquire videos and/or images corresponding to a view of the exterior of the driver's cab 3 that would be viewed by the driver C of the crawler vehicle 1 through a possible rear-view mirror, while the driver C is seated on the seat 4.

In accordance with further embodiments of the present disclosure (not shown in the figures), each acquisition device 14, 15, 16 may be mounted on the shovel 12 or on the winch 13 or along a ski run or on an aerial vehicle, in certain instances unmanned, such as an aerial drone.

In additional embodiments, the crawler vehicle 1 may comprise further acquisition devices (not shown in the accompanying figures) arranged, for example, along lateral portions of the crawler vehicle 1 to detect data indicative of the environment surrounding the crawler vehicle 1 in directions transverse to the travelling direction D.

In additional embodiments, the crawler vehicle 1 comprises a sensor assembly 18 configured to detect operational information comprising one or more of operational parameters of the crawler vehicle 1, information on the operations to be performed and/or information about the characteristics of the environment surrounding the crawler vehicle 1.

In accordance with certain embodiments (not shown in the figures), the sensor assembly 18 can be arranged aboard other crawler vehicles or aboard an aerial vehicle, in certain instances unmanned, such as an aerial drone.

In certain embodiments, the sensor assembly 18 comprises one or more of a range sensor configured to detect a residual range of the crawler vehicle 1; a status sensor configured to detect a status of operation of the propulsion system 9 and/or the assembly of accessory devices 10; a recognition sensor configured to detect any obstacles around the crawler vehicle 1; a lidar sensor configured to detect the characteristics of the snowpack M; and/or a satellite navigation device (such as a Global Navigation Satellite System (“GNSS”) type device) which is configured to detect the position and three-dimensional orientation of the crawler vehicle 1.

Furthermore, the control system 6 of certain embodiments comprises a processing module 19 configured to process the videos and/or the images acquired by the acquisition device 14, 15, 16 and to identify a position and/or a conformation of reference elements in the environment surrounding the crawler vehicle 1 based on or as a function of the processed data.

In certain embodiments, the processing module 19 is configured to identify a position of objects and/or living beings in the environment surrounding the crawler vehicle 1 based on or as a function of the processed data and/or to determine a conformation of the environment surrounding the crawler vehicle 1 based on or as a function of the processed data. In certain embodiments, the processing module 19 implements artificial intelligence algorithms.

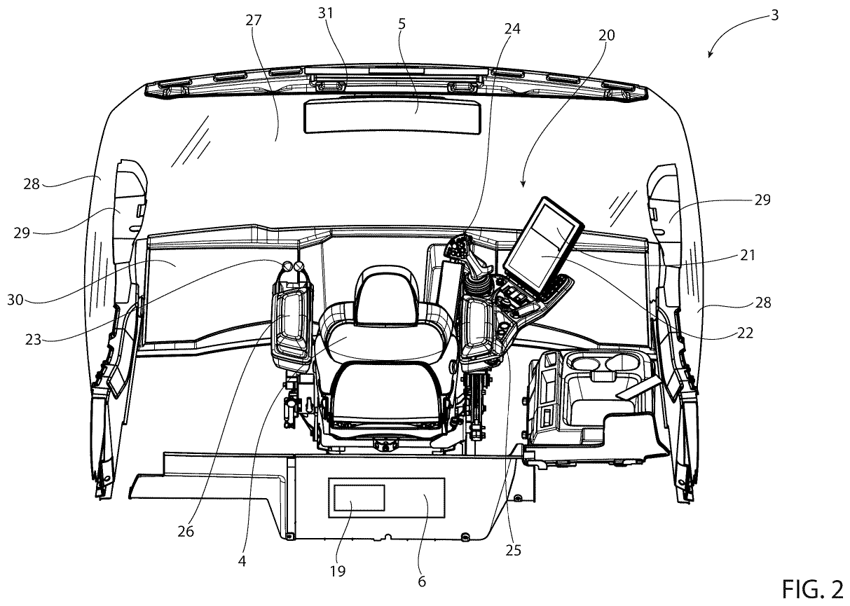

With reference to FIGS. 2 to 5, the crawler vehicle 1 comprises a user interface 20, which is in communication with the control system 6 and is configured to receive commands from the driver C of the crawler vehicle 1 and to transmit the commands to the control system 6.

In certain embodiments, the user interface 20 is arranged in the proximity of the seat 4 so as to be within reach of the driver C of the crawler vehicle 1 when the driver C is seated on the seat 4.

In the non-limiting embodiment of the present disclosure described and shown, the user interface 20 comprises an interface screen 21 provided with one or more of a touch sensor 22 configured to detect a touch and/or a tap, a control lever 23, and a joystick 24.

In certain embodiments, the interface screen 21, based on the touch sensor 22, is of the touch screen or touch sensitive type and the control system 6 is configured to receive selections via touches and/or taps on the interface screen 21 by the driver C of the crawler vehicle 1.

It is understood that the user interface 20 does not necessarily comprise all the devices mentioned above. For example, the user interface 20 may comprise any one or two of the above-mentioned devices selected from the interface screen 21, the control lever 23, and the joystick 24.

In practice, the user interface 20 enables the driver C to control the movement of the crawler vehicle 1 and the operation of the accessory devices 10. In certain embodiments, the control lever 23 and the joystick 24 are configured to drive the advancement of the crawler vehicle 1 and to control the movements of the accessory devices 10.

In certain embodiments, the control system 6 is configured to control the screen of the display 5 so as to change the operative information reproduced by each screen portion based on or as a function of the commands given by the driver C of the crawler vehicle 1 by the user interface 20.

In the non-limiting embodiment of the present disclosure described and shown herein, the seat 4 comprises a pair of armrests 25 and 26, to which the user interface 20 is coupled. In more detail, the joystick 24 and the interface screen 21 are arranged on the armrest 25. The control lever 23 is arranged on the armrest 26.

In accordance with certain embodiments, the driver's cab 3 comprises a windscreen 27, two lateral windows 28, two lateral uprights 29, each of which is arranged between the windscreen 27 and the respective lateral window 28, a lower platform 30, and a roof 31. In certain embodiments, the seat 4 is mounted on the lower platform 30 in a central position of the driver's cab 3.

In accordance with certain embodiments (not shown in the figures), the driver's cab 3 may comprise further seats for possible passengers of the crawler vehicle 1 arranged alongside the seat 4.

With reference to FIG. 2, another embodiment of the crawler vehicle 1 is shown in which the display 5 is arranged in front of the seat 4 and extends from the roof 31 of the driver's cab 3. In certain embodiments, the display 5 hangs from the roof 31 near the windscreen 27 and extends horizontally. In practice, the display 5 is arranged in the driver's cab 3 so as to maintain an unobstructed view of the driver C of the crawler vehicle 1 through a central portion of the windscreen 27 while the driver C is seated on the seat 4.

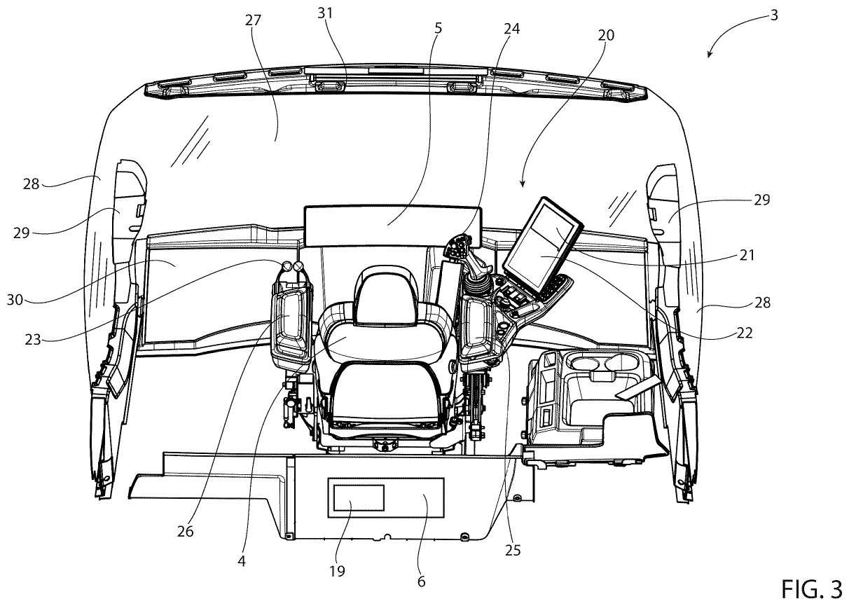

With reference to FIG. 3, another embodiment of the crawler vehicle 1 is shown in which the display 5 is arranged in front of the seat 4 and is supported by the lower platform 30 of the driver's cab 3. In certain embodiments, the display 5 is mounted on the lower platform 30 near the windscreen 27 and extends horizontally.

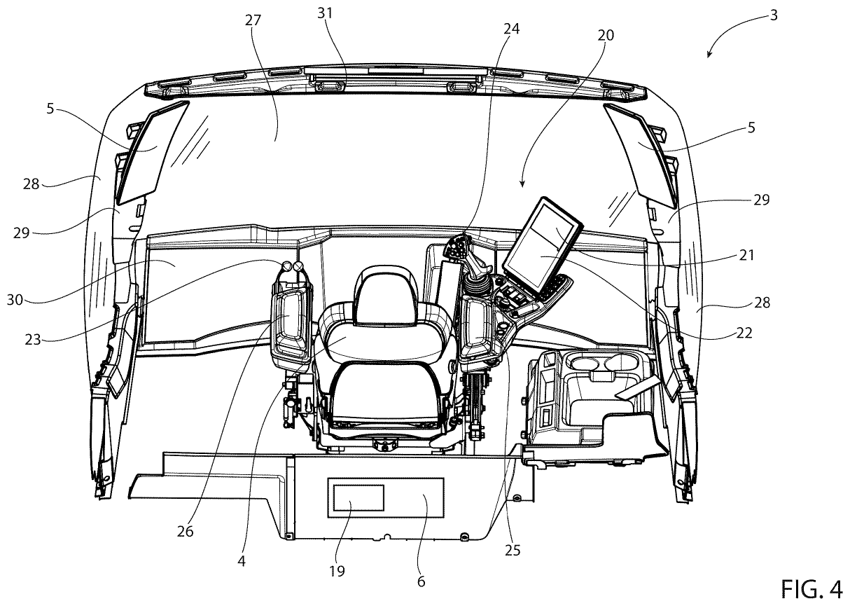

With reference to FIG. 4, another embodiment of the crawler vehicle 1 is shown wherein the crawler vehicle 1 comprises two displays 5, each of which is arranged on the side of the seat 4 and is fixed to one of the lateral uprights 29 of the driver's cab 3. In certain embodiments, each display 5 extends vertically and follows the profile of the respective lateral upright 29.

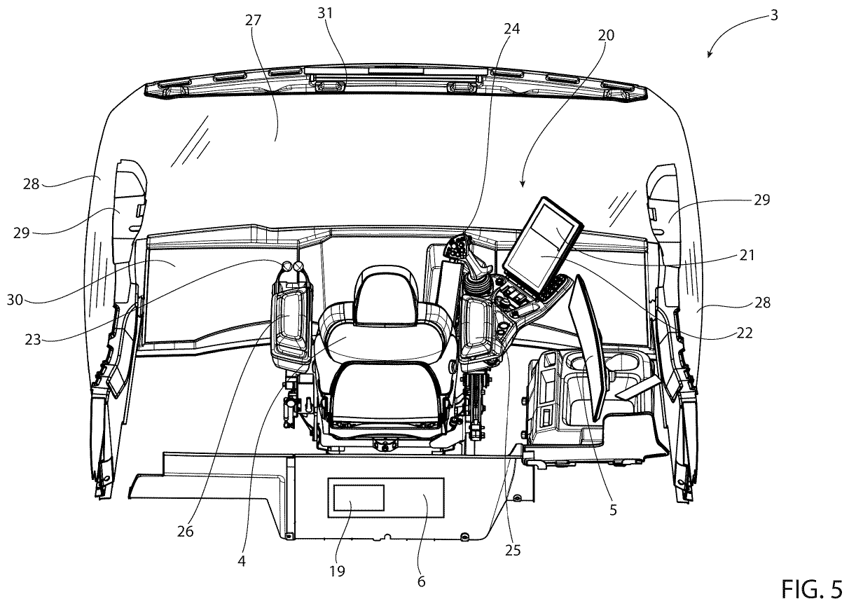

With reference to FIG. 5, another embodiment of the crawler vehicle 1 is shown wherein the display 5 is arranged on the side of the seat 4 and, in certain instances, alongside the seat 4. In accordance with this embodiment, the display 5 extends horizontally and is arranged between the seat 4 and one of the lateral windows 28.

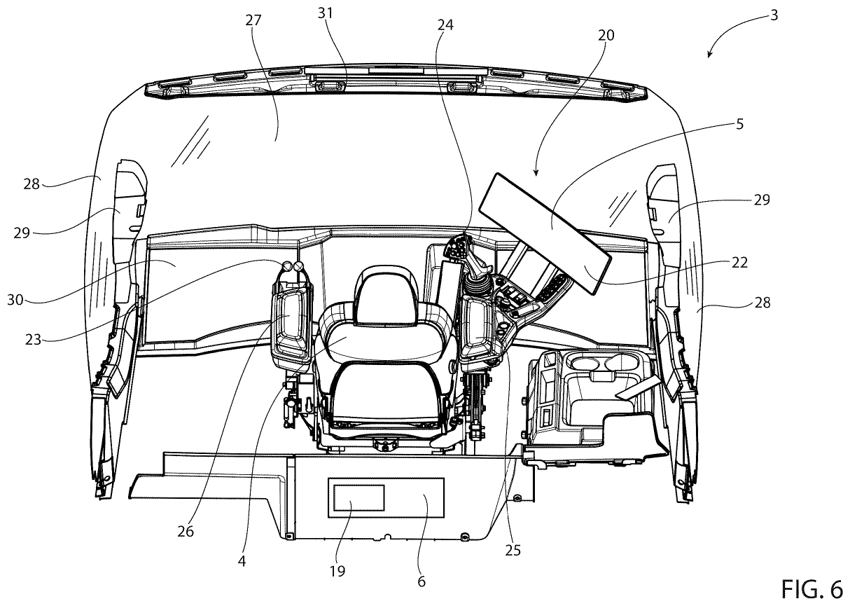

With reference to FIG. 6, another embodiment of the crawler vehicle 1 is shown, wherein the display 5 is supported by the armrest 25. In accordance with this embodiment, the display 5 is part of the user interface 20 and, in certain instances, the interface screen 21 (FIGS. 2 to 5) is omitted. In more detail, the display 5 extends horizontally and is provided with the touch sensor 22.

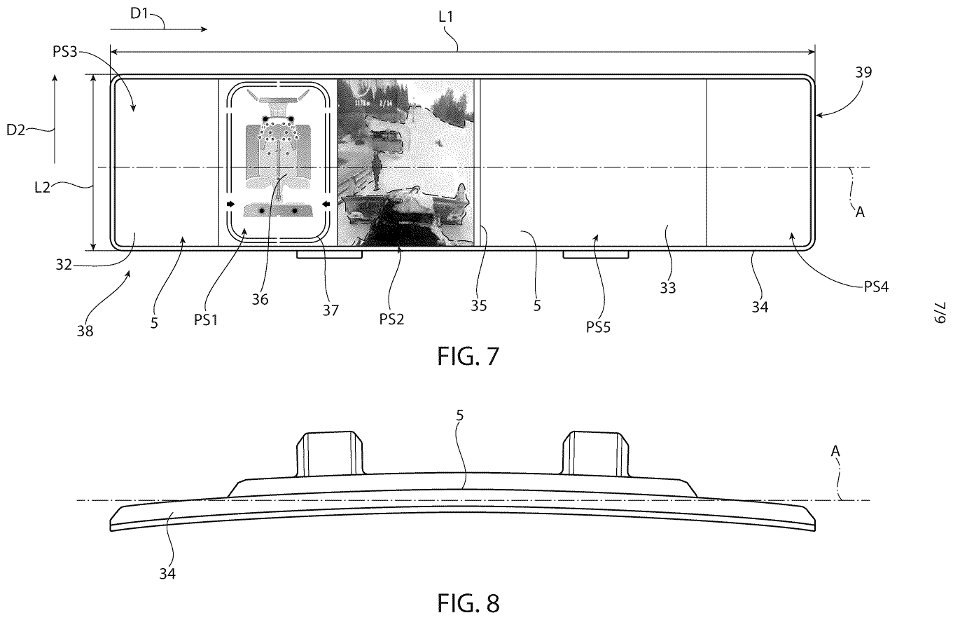

With reference to FIG. 7, the display 5 has an elongated conformation and extends along a longitudinal axis A. In certain embodiments, the display 5 extends for a length L1 along a direction D1 substantially parallel to the longitudinal axis A and for a length L2 along a direction D2 substantially perpendicular to the direction D1.

In the non-limiting embodiment of the present disclosure described and shown, the length L1 is three times longer than the length L2. In certain instances, the length L1 is equal to about four times the length L2.

In certain embodiments, the display 5 is divided into two separate sectors 32 and 33. In more detail, the display 5 comprises a frame housing 34 provided with a central element 35, which separates the sectors 32 and 33.

In accordance with a display mode, the control system 6 is configured to control the screen S displayed by the display 5 so as to display in a screen portion PS1 of the plurality of screen portions a representation 36 of at least a portion of the crawler vehicle 1 and a visual indicator 37 indicative of the presence of obstacles in proximity of the crawler vehicle 1.

In certain embodiments, the control system 6 is configured to control the screen S displayed by the display 5 so as to display the videos and/or images acquired by the acquisition device 14 in a screen portion PS2 of the plurality of screen portions.

Furthermore, the control system 6 of certain embodiments is configured to control the screen S displayed by the display 5 so as to display, in real time, in a screen portion PS3, PS4 of the plurality of screen portions the videos and/or images acquired by the acquisition device 15 or by the acquisition device 16 in the direction substantially opposite to the travelling direction D of the crawler vehicle 1.

In accordance with the operational configuration described and shown, the screen portion PS3 reproduces the videos and/or images acquired by one of the acquisition devices 16 and the screen portion PS4 reproduces the videos and/or the images acquired by the other of the acquisition devices 16. In other words, the screen portion PS3 reproduces videos and/or images corresponding to a view that would be displayed by the driver C of the crawler vehicle 1 through a possible left rear-view mirror, while the driver C is seated on the seat 4. The screen portion PS4 reproduces the videos and/or the images corresponding to a view that would be displayed by the driver C of the crawler vehicle 1 through a possible right rear-view mirror, while the driver C is seated on the seat 4.

In certain embodiments, the control system 6 is configured to display the screen portions PS3 and PS4 at respective lateral ends 38, 39 of the screen S.

Further, the control system 6 of certain embodiments is configured to control the screen S displayed by the display 5 so as to display in a screen portion PS5 of the plurality of screen portions further operative information. In certain embodiments, the further operative information comprises one or more of operational parameters of the crawler vehicle 1, a tachometer, information on residual fuel, information on the electrical status of the crawler vehicle 1, information on possible failures of the crawler vehicle 1, two-or three-dimensional views of the crawler vehicle 1, dynamic views of the crawler vehicle 1, user manuals, instructions for use of the user interface 20, an interactive guide, information for servicing the crawler vehicle 1, information for controlling the heating of the driver's cab 3, radio data, telephony data, information for connection to mobile electronic devices, snow depth information, terrain slope information, information on managing a fleet of crawler vehicles 1, information on missions and/or activities to be performed by the driver of the crawler vehicle 1, information on the configuration of the crawler vehicle 1 and accessory devices 10, information on a ski facility, identification data of a particular driver of the crawler vehicle 1, a navigation system, smart applications to support the use of the crawler vehicle 1, a communication system with further vehicles, and/or information for a remote control of the crawler vehicle 1.

In the case described and shown, the screen portions PS1, PS2, PS3, PS4 and PS5 are aligned along the longitudinal axis A of the display 5. In certain embodiments, the screen portions PS1, PS2 and PS3 are arranged in the sector 32 and the screen portions PS4 and PS5 are arranged in the sector 33. It is understood that the screen portions PS1, PS2, PS3, PS4 and PS5 may be displayed on the display 5 in different positions or in accordance with further configurations than shown in FIG. 7.

With reference to FIG. 8, in plan the display 5 has a curved profile with respect to the longitudinal axis A.

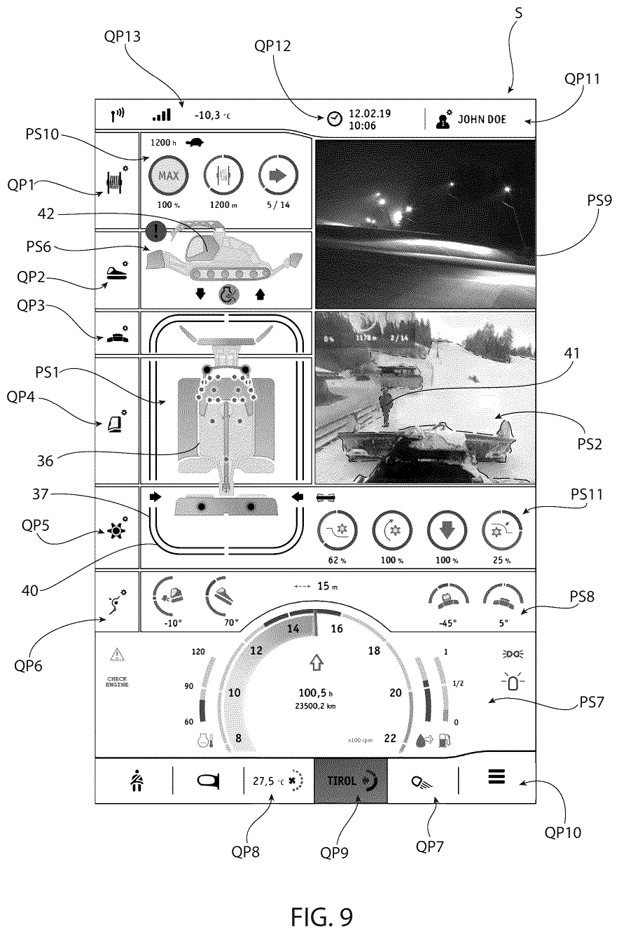

With reference to FIG. 9, the screen portion PS1 schematically reproduces the plan view 36 of the crawler vehicle 1. In certain embodiments, the representation 36 comprises a representation of the accessory devices 10 connected to the crawler vehicle 1.

In the case described and shown, the representation 36 comprises the representation of the tiller 11 and of the shovel 12. In more detail, the representation of the tiller 11 comprises two lateral wings configured to vary their relative positions and the representation of the shovel 12 comprises a central blade and two lateral blades coupled to the central blade and configured to vary their position with respect to the central blade.

In certain embodiments, the representation 36 of the crawler vehicle 1 is two-dimensional or three-dimensional. In more detail, the control system 6 is configured to control the orientation of the representation 36 based on or as a function of the commands given by the driver of the crawler vehicle 1 through the user interface 20. In this way, it is possible to rotate the representation 36 of the crawler vehicle 1 based on or as a function of the particular operational needs.

Furthermore, the visual indicator 37 of certain embodiments comprises at least one proximity line 40 arranged at least partially around the representation 36 of the crawler vehicle 1. The control system 6 is configured to control a coloring of the proximity line 40 based on or as a function of a distance of an obstacle from a certain portion of the crawler vehicle 1. In certain embodiments, the control system 6 is configured to control the coloring of the proximity line 40 at a position of the representation 36 corresponding to the portion of the crawler vehicle 1 in proximity of the obstacle.

In certain embodiments, the processing module 19 of the control system 6 is configured to process the videos and/or the images detected by the acquisition device 14, to identify a position and/or a conformation of reference elements 41 in the environment surrounding the crawler vehicle 1 based on or as a function of the processed videos and/or images, and to indicate the contours of each reference element 41 in the screen portion PS2 displayed by the display 5. In more detail, the processing module 19 comprises a memory in which a database containing comparison images of a plurality of reference elements 41 of different types is stored. The processing module 19 is configured to classify each reference element 41 based on or as a function of the processed data and the comparison images stored in the database. In the non-limiting embodiment of the present disclosure described and shown, the processing module 19 is configured to classify the reference element 41 as a person.

Further, the control system 6 of certain embodiments is configured to control the screen S displayed by the display 5 so as to display in a screen portion PS6 of the plurality of screen portions a representation 42 of the crawler vehicle 1. In certain embodiments, the representation 42 is a schematic side view of the crawler vehicle 1 and shows the accessory devices 10 currently connected to the crawler vehicle 1. In more detail, the representation 42 comprises a representation of the tensioning of the tracks 7 of the crawler vehicle 1 by arrows positioned below the crawler vehicle 1 and indicating respective directions associated with a tensioning of the tracks 7.

Furthermore, the control system 6 of certain embodiments is configured to control the screen S displayed by the display 5 so as to display on a screen portion PS7 of the plurality of screen portions one or more of data relating to the advancement speed of the crawler vehicle 1, data relating to the engine revolutions of the crawler vehicle 1, data relating to a control light of the propulsion system 9, total working hours in the life of the crawler vehicle 1, the total distance travelled in the life of the crawler vehicle 1, the temperature of a fluid functional to the operation of the crawler vehicle 1 (e.g., the temperature of a liquid of the propulsion system 9), and/or the level or levels of residual power supply energy of the propulsion system 9 (e.g., the level of residual fuel in a tank when the propulsion system 9 comprises an internal combustion engine or of the level of residual electrical energy in a battery when the propulsion system 9 comprises an electric motor or fuel and electric power levels when the propulsion system 9 is hybrid and comprises a combustion engine and an electric motor).

Furthermore, the control system 6 of certain embodiments is configured to control the screen S displayed by the display 5 so as to display on a screen portion PS8 of the plurality of screen portions data relating to an inclination of the crawler vehicle 1 with respect to a longitudinal axis, in particular data relating to the roll angle of the crawler vehicle 1 around a roll axis; and/or data relating to an inclination of the crawler vehicle 1 around a transverse axis, in particular data relating to the pitch angle around a pitch axis.

Further, the control system 6 of certain embodiments is configured to control the screen S displayed by the display 5 so as to display in a screen portion PS9 of the plurality of screen portions a frequency tuning for stations of a car radio.

Furthermore, the control system 6 of certain embodiments is configured to control the screen S displayed by the display 5 so as to display in a screen portion PS10 of the plurality of screen portions values relating to the winch 13, such as one or more of the following values: unwound rope length, towing force in absolute value and/or in percentage with respect to a maximum towing force.

Furthermore, the control system 6 of certain embodiments is configured to control the screen S displayed by the display 5 so as to display in a screen portion PS11 of the plurality of screen portions a schematic representation of a tiller 11, and, in certain instances, of any tracing devices connected thereto, and values relating to the tiller 11, such as one or more of the following values: shaft rotation speed, shaft rotation direction, angle of inclination of the tiller 11 with respect to the snowpack, and/or percentage of snow recirculation within a working chamber of the tiller 11.

The display 5 is further configured to display a further plurality of screen portions QP1-QP13 arranged along at least one of the outer edges of the screen S, such as along three outer edges of the screen S.

In certain embodiments, the control system 6 is configured to control the screen S displayed by the display 5 so as to display one or more of the following further plurality of screen portions: a further screen portion QP1 representing a schematic symbol of the winch 13; a further screen portion QP2 representing a schematic symbol of the crawler vehicle 1; a further screen portion QP3 representing a schematic symbol of the shovel 12; a further screen portion QP4 representing a schematic symbol of the driver's cab 3; a further screen portion QP5 representing a schematic symbol of a shaft of the tiller 11; a further screen portion QP6 representing a schematic symbol of the tiller 11; a further screen portion QP7 representing a symbol of lights; a further screen portion QP8 representing a symbol of a fan and a temperature value; a further screen portion QP9 representing a symbol of a radio tuning and the name of a radio station; a further screen portion QP10 representing a generic symbol (including but not limited to parallel lines); a further screen portion QP11 schematically representing a person and the name of a driver of the crawler vehicle 1; a further screen portion QP12 schematically representing date and time; and/or a further screen portion QP13 representing an external temperature and/or symbols indicating reception values of a data communication signal.

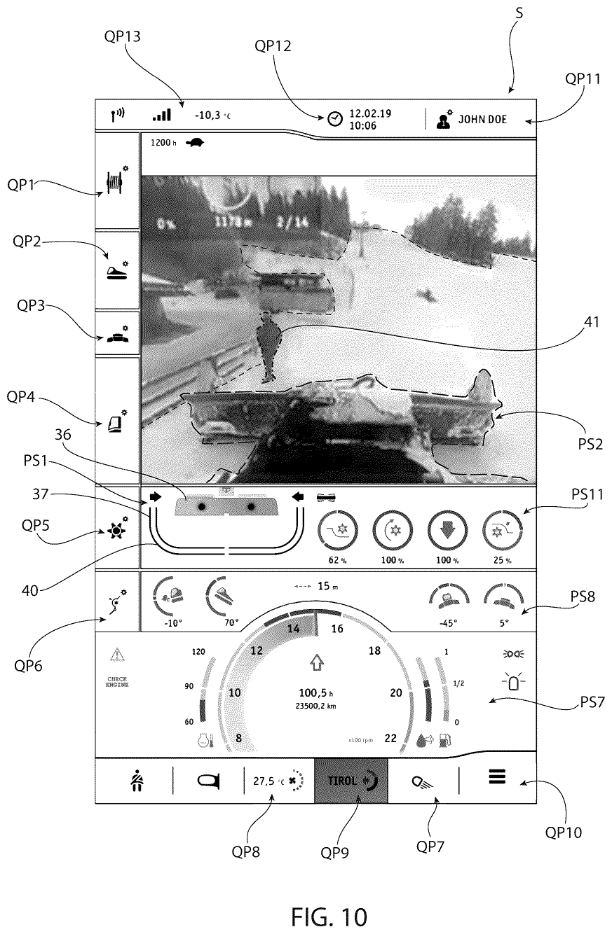

With reference to FIG. 10, a detail of the screen S displayed by the display 5 in accordance with a further display mode is shown. In accordance with this configuration, the control system 6 is configured to control the screen S displayed by the display 5 so as to display in a magnified manner the portion of the screen PS2 that reproduces the videos and/or the images acquired by the acquisition device 14.

Furthermore, the control system 6 of certain embodiments is configured to control the screen S displayed by the display 5 so as to display in the screen portion PS1 the representation 36 of the crawler vehicle 1 in a partial manner. In more detail, the rear portion of the crawler vehicle 1, in particular of the tiller 11 of the crawler vehicle 1, is reproduced in the screen portion PS1. The proximity line 40 of the visual indicator 37 is arranged partially around the representation 36 of the rear portion of the crawler vehicle 1.

In accordance with an operating mode of certain embodiments, the control system 6 is configured to store the different configurations of the screens S of the display 5 selected by different drivers C and to associate a respective driver code with the stored configurations. The control system 6 is configured to recall and display on the display 5 one of the stored configurations when the driver code associated with one of the stored configurations is entered.

Furthermore, the control system 6 of certain embodiments is configured to operate in an alternative display mode in which the display of one or more of any of the operative information described above may be extended to two or more screen portions PS1, . . . , PS11 and may be reproduced transparently above further operative information. By way of example, in accordance with a variant embodiment of the present disclosure, the control system 6 is divided into a main control unit dedicated only to controlling the crawler vehicle 1 and accessory devices 10 and a secondary control unit dedicated to controlling the display 5 and associated with the main control unit to send and receive data.

It is evident that variants can be made to the present disclosure without, however, departing from the scope of protection of the appended claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

The invention is claimed as follows:

1. A crawler vehicle configured to advance in a travelling direction and comprising:
a frame;
a driver cabin mounted on the frame;
a seat arranged inside the driver cabin;
a display arranged in the driver cabin and configured to display a screen reproducing operative information, wherein the screen is divided into a plurality of screen portions; and
a control system in communication with the display and configured to control the screen displayed by the display.

2. The crawler vehicle of claim 1, wherein the operative information comprises at least one of an operational parameter of the crawler vehicle, information on an operation to be carried out, information on a characteristic of an environment surrounding the crawler vehicle, an image acquired outside the driver cabin, and a video acquired outside the driver cabin.

3. The crawler vehicle of claim 1, further comprising a user interface in communication with the control system and configured to: receive a command from a driver of the crawler vehicle and transmit the command to the control system.

4. The crawler vehicle of claim 3, wherein the user interface is positioned to be within reach of the driver of the crawler vehicle when the driver is seated on the seat.

5. The crawler vehicle of claim 3, wherein the control system is configured to control the screen of the display to modify the operative information reproduced by each screen portion based on a command received, through the user interface, from the driver of the crawler vehicle.

6. The crawler vehicle of claim 3, wherein the user interface comprises at least one of a control lever, a joystick and a touch sensor configured to detect at least one of a touch and a swipe.

7. The crawler vehicle of claim 1, wherein the display extends for a first length along a first direction and for a second length along a second direction perpendicular to the first direction, the first length is greater than three times the second length.

8. The crawler vehicle of claim 1, wherein the display defines a curved profile.

9. The crawler vehicle of claim 1, wherein the display is one of arranged in front of the seat, and arranged to the side of the seat.

10. The crawler vehicle of claim 1, wherein:
the driver cabin comprises a windscreen, two lateral windows, two lateral uprights each of which is arranged between the windscreen and the respective lateral window, a lower platform, and a roof; and
the display extends from the roof of the driver cabin.

11. The crawler vehicle of claim 1, wherein the control system is configured to control the screen displayed by the display to display, in a first screen portion of the plurality of screen portions, a representation of a portion of the crawler vehicle and a visual indicator indicative of a presence of any obstacles to the crawler vehicle.

12. The crawler vehicle of claim 11, wherein:
the visual indicator comprises a proximity line arranged at least partially around the representation of the portion of the crawler vehicle, and
the control system is configured to control a colouring of the proximity line based on a distance of an obstacle from that portion of the crawler vehicle.

13. The crawler vehicle of claim 11, wherein the representation of the portion of the crawler vehicle is one of a two-dimensional representation and a three-dimensional representation.

14. The crawler vehicle of claim 11, wherein the control system is configured to control a orientation of the representation of the portion of the crawler vehicle based on a command received, through a user interface, from a driver of the crawler vehicle.

15. The crawler vehicle of claim 1, further comprising an acquisition device in communication with the control system and configured to acquire at least one of a video of an environment surrounding the crawler vehicle and an image of the environment surrounding the crawler vehicle, wherein the control system is configured to control the screen displayed by the display to display the at least one of the video and the image in a first screen portion of the plurality of screen portions.

16. The crawler vehicle of claim 15, wherein the control system is configured to process the at least one of the video and the image to identify at least one of a position and a conformation of reference elements in the environment surrounding the crawler vehicle and to indicate a contour of each reference element in the first screen portion displayed by the display.

17. The crawler vehicle of claim 15, wherein the acquisition device points in a direction opposite to the travelling direction and the control system is configured to control the screen displayed by the display to display, in real time and in a second screen portion of the plurality of screen portions, the at least one of the video and the image in the direction opposite to the travelling direction.

18. The crawler vehicle of claim 17, wherein the control system is configured to display the second screen portion in a lateral end of the screen.

19. The crawler vehicle of claim 1, wherein the control system is configured to control the screen displayed by the display to display, in a first screen portion of the plurality of screen portions, further operative information comprising at least one of: an operational parameter of the crawler vehicle, a tachometer, information on residual fuel, information on an electrical status of the crawler vehicle, information related to any faults of the crawler vehicle, a two-dimensional view of the crawler vehicle, a three-dimensional view of the crawler vehicle, a dynamic view of the crawler vehicle, a user manual, a user interface instruction, information associated with a maintenance of the crawler vehicle, information associated with a control of a heating of the driver cabin, radio data, telephony data, information associated with connecting with a mobile electronic device, information on a snow depth, information on a slope of ground, information on a management of a fleet of crawler vehicles, information relating to at least one of a mission and an activity to be carried out by a driver of the crawler vehicle, information on a configuration of the crawler vehicle, information on an auxiliary device, information relating to a ski resort, data identifying a specific driver of the crawler vehicle, a navigation system, an intelligent application supporting the use of the crawler vehicle, a communication system with other vehicles, and information associated with a remote control of the crawler vehicle.
